(19) United States
(12) Patent Application Publication
(10) Pub. No.: US 2025/0259479 A1
(43) Pub. Date: Aug. 14, 2025

(54) HUMAN ACTIVITY ANALYSIS BASED ON SKELETON AND DEEP LEARNING TRANSFORMER

(71) Applicants: Amit Gur, Zichron-Yaakov (IL); Talya Natanya, Petach Tikva (IL); Mohr Wenger, Gedera (IL); Uzi Sarel, Zichron-Yaakov (IL)

(72) Inventors: Amit Gur, Zichron-Yaakov (IL); Talya Natanya, Petach Tikva (IL); Mohr Wenger, Gedera (IL); Uzi Sarel, Zichron-Yaakov (IL)

(21) Appl. No.: 19/193,352

(22) Filed: Apr. 29, 2025

(51) Int. Cl. G06V 40/20; G06V 10/82

(52) U.S. Cl. CPC G06V 40/23; G06V 10/82

(57) ABSTRACT

Systems and methods for automatically analyzing movements to identify anomalies and incorrect actions. An artificial intelligence-based digital system is provided that can monitor PT exercises. The systems and methods include a scalable solution to detect incorrect actions or anomalies in PT exercises in real time without using manual definitions. Furthermore, the system includes explanations for detected anomalies, enhancing the real-time feedback and adjustment of treatment plans. Providing real-time feedback improves treatment results by ensuring accurate performance of the exercise by the patient. The systems and methods can include extracting skeleton sequences of an exerciser performing an exercise from 2D videos. A neural network classifies the exercise being performed and identifies the side of the body performing the exercise. The exercise performed by the exerciser can be compared to an expert version of the exercise, and anomalies in the exercise performed by the exerciser can be detected.

### CROSS-REFERENCE TO RELATED APPLICATION

This application is related to concurrently filed U.S. Application titled “Human-Artificial Intelligence Interaction for Physical Therapy Measurements”, which is hereby incorporated by reference in its entirety.

### TECHNICAL FIELD

This disclosure relates generally to object recognition, and in particular to human activity analysis based on skeleton dataset, deep learning transformer, and latent space.

### BACKGROUND

In Physical Therapy (PT) treatment, it is important to accurately identify when a patient performs an exercise incorrectly and provide corrective actions. Additionally, PT treatment plans are adjusted based on detected movement anomalies. The variety of exercises used by the Physical Therapy (PT) community is vast, ranging from 5,000 to 15,000 unique exercises. For each exercise, the number of potential incorrect movements or anomalies is also extensive and unpredictable. Furthermore, while performing their PT exercises, patients may also engage in many unrelated activities that are not part of the required exercise regimen. These factors present challenges to the development of automated systems for providing PT treatment.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a deep learning system, in accordance with various embodiments.

FIG. 2 illustrates an example of a human activity analysis system, in accordance with various embodiments.

FIG. 3 illustrates an example of a graph that may be displayed to a clinician, in accordance with various embodiments.

FIG. 4 illustrates an example overview of a deep action analysis development pipeline 400, in accordance with various embodiments, in accordance with various embodiments.

FIGS. 5A and 5B illustrate examples of a skeleton arrangement, in accordance with some embodiments.

FIG. 6 shows an example of a 3D array output from the arrange skeleton module, in accordance with various embodiments.

FIG. 7 illustrates an example deep action analysis pipeline, in accordance with various embodiments.

FIG. 8 illustrates a data preparation example, in accordance with various embodiments.

FIG. 9 illustrates an example generation of a 3D array, in accordance with various embodiments.

FIG. 10 illustrates an example of a vision transformer, in accordance with various embodiments.

FIG. 11 illustrates an example of a transformer encoder, in accordance with various embodiments.

FIG. 12 illustrates an example of three arrays that may be analyzed by a vision transformer, in accordance with various embodiments.

FIG. 13 is a flowchart showing a method of human activity analysis, in accordance with various embodiments.

FIG. 14 is a block diagram of an example computing device, in accordance with various embodiments.

### DETAILED DESCRIPTION

### Overview

An artificial intelligence-based digital system is provided herein that can monitor PT exercises and automatically analyze movements to identify both anomalies and incorrect actions. The systems and methods include a scalable solution to detect incorrect actions or anomalies in PT exercises without using manual definitions. Furthermore, the system includes explanations for detected anomalies, enhancing the real-time feedback and adjustment of treatment plans.

In conventional automated PT treatment systems, the “real-time feedback” is defined manually per exercise as a list of rules. While some potential anomalies and/or mistakes may be added for some exercises, the list is limited. Additionally, in conventional automated PT systems, feedback is not based on an analysis of actual exercise performance. Systems and methods are provided herein for a scalable artificial intelligence-based digital system that can analyze PT exercises and detect anomalies in real-time. Providing real-time feedback improves treatment results by ensuring accurate performance of the exercise by the patient. The system can save PT time by pinpointing exercise anomalies for the PT to review, allowing the PT to focus on exercises that a patient needs help with and allowing the PT to skip review of exercises the patient performed accurately.

In various implementations, the system can include a list of supported exercises, an expert definition of each supported exercise, and a video of an expert performing each exercise. In various examples, the expert definition can be a definition from a PT.

In various implementations, systems and methods are provided to extract skeleton sequences from 2D videos. In particular, the systems and method extract skeleton sequences of an exerciser performing an exercise. A neural network is used to classify the exercise being performed and classify the side of the body performing the exercise. In various examples, the exercise performed by the exerciser can be compared to an expert version of the exercise, and anomalies in the exercise performed by the exerciser can be detected. In some examples, the system can provide feedback to the exerciser regarding anomalies and/or incorrect exercise movements in real time, while the exerciser is performing the exercise. Thus, in some examples, using the systems provided herein, the exerciser can perform the exercises more effectively when a physical therapist or trainer is not present, helping avoid incorrect practice.

For purposes of explanation, specific numbers, materials, and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or systems. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

### Example DNN System

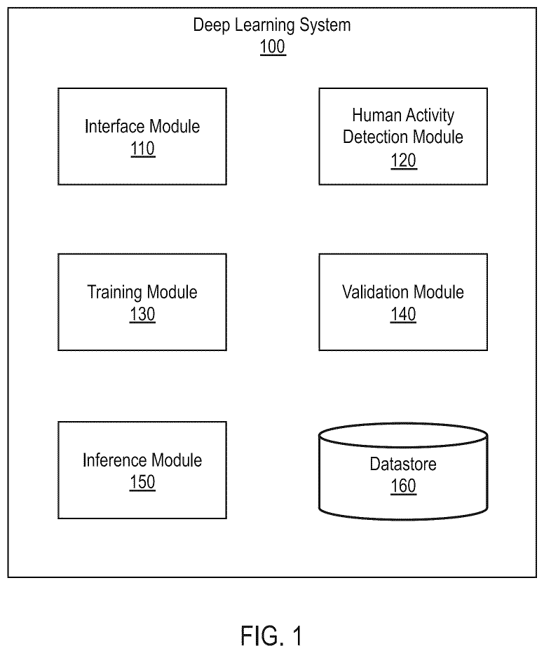

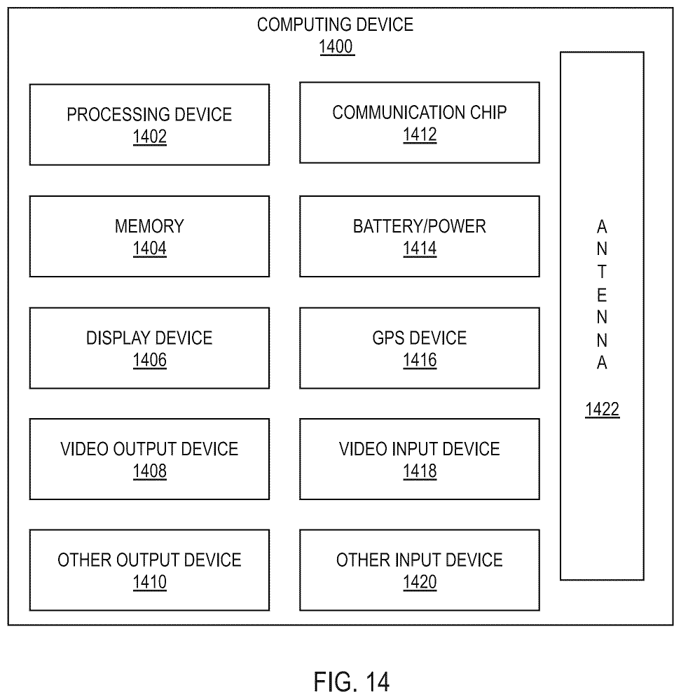

FIG. 1 is a block diagram of an example DNN system 100, in accordance with various embodiments. The DNN system 100 trains DNNs for various tasks, including human activity analysis. The DNN system 100 includes an interface module 110, a human activity analysis module 120, a training module 130, a validation module 140, an inference module 150, and a datastore 160. In other embodiments, alternative configurations, different or additional components may be included in the DNN system 100. Further, functionality attributed to a component of the DNN system 100 may be accomplished by a different component included in the DNN system 100 or a different system. The DNN system 100 or a component of the DNN system 100 (e.g., the training module 130 or inference module 150) may include the computing device 1400 in FIG. 14.

The interface module 110 facilitates communications of the DNN system 100 with other systems. As an example, the interface module 110 supports the DNN system 100 to distribute trained DNNs to other systems, e.g., computing devices configured to apply DNNs to perform tasks. As another example, the interface module 110 establishes communications between the DNN system 100 with an external database to receive data that can be used to train DNNs or input into DNNs to perform tasks. In some embodiments, data received by the interface module 110 may have a data structure, such as a matrix. In some embodiments, data received by the interface module 110 may be an image, a series of images, and/or a video stream.

The human activity analysis module 120 identifies user exercises and analyzes the exercises to identify any anomalies. The human activity analysis module 120 performs human activity analysis in real-time. In general, the human activity analysis module 120 includes multiple components which can perform functions such as extracting skeleton sequences, arranging skeleton sequences in time as a three-dimensional (3D) array, identifying user exercises, and analyzing exercises to identify anomalies.

During training, the human activity analysis module 120 can use a training data set including videos of an expert performing the exercises, with each video labeled with labels indicating which exercise is being performed, which side (if applicable), and how many repetitions are performed. In various examples, as described herein, the human activity analysis module 120 includes one or more neural networks for processing input images and videos. In some examples, the human activity analysis module 120 extracts skeleton sequences as described herein, and arranges the skeleton sequences in time as a 3D array. The human activity analysis module 120 can arrange the joints from the skeleton sequence into multiple groups of joints, each representing a human body part that moves together when performing exercises. The movement of each group of joints over a selected time period (e.g., a few seconds) is represented in a matrix. In various implementations, the human activity analysis module 120 includes a deep learning model for classifying the exercise based on the matrix data. In some examples, the deep learning model includes a transformer.

In various examples, as described herein, the human activity analysis module 120 includes one or more neural networks for processing input videos. In some examples, the human activity analysis module 120 includes one or more deep neural networks (DNN) for processing input images. The training module 130 trains DNNs using training datasets. In some embodiments, a training dataset for training a DNN may include one or more images and/or videos, each of which may be a training sample. In some examples, the training module 130 trains the human activity analysis module 120. The training module 130 may receive real-world video data for processing with the human activity analysis module 120 as described herein. In some embodiments, the training module 130 may input different data into different layers of the DNN. For every subsequent DNN layer, the input data may be less than the previous DNN layer. The training module 130 may adjust internal parameters of the DNN to minimize a difference between training data output and the input data processed by the human activity analysis module 120.

In some embodiments, a part of the training dataset may be used to initially train the DNN, and the rest of the training dataset may be held back as a validation subset used by the validation module 140 to validate performance of a trained DNN. The portion of the training dataset not including the tuning subset and the validation subset may be used to train the DNN.

The training module 130 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 1, 10, 50, 100, or even larger.

The training module 130 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include 3 channels). A pooling layer is used to reduce the spatial volume of input image after convolution. It is used between 2 convolution layers. A fully connected layer involves weights, biases, and neurons. It connects neurons in one layer to neurons in another layer. It is used to classify images between different categories by training.

In the process of defining the architecture of the DNN, the training module 130 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 130 defines the architecture of the DNN, the training module 130 inputs a training dataset into the DNN. The training dataset includes a plurality of training samples. An example of a training dataset includes a series of images of a video stream. Unlabeled, real-world video is input to the human activity analysis module, and processed using the human activity analysis module parameters of the DNN to produce two different model-generated outputs: a first time-forward model-generated output and a second time-reversed model-generated output. In the backward pass, the training module 130 modifies the parameters inside the DNN (“internal parameters of the DNN”) to minimize the differences between the first model-generated output is and the second model generated output. The internal parameters include weights of filters in the convolutional layers of the DNN. In some embodiments, the training module 130 uses a cost function to minimize the differences.

The training module 130 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 130 finishes the predetermined number of epochs, the training module 130 may stop updating the parameters in the DNN. The DNN having the updated parameters is referred to as a trained DNN.

The validation module 140 verifies accuracy of trained DNNs. In some embodiments, the validation module 140 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 140 may determine an accuracy score measuring the precision, recall, or a combination of precision and recall of the DNN. The validation module 140 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 140 may compare the accuracy score with a threshold score. In an example where the validation module 140 determines that the accuracy score of the augmented model is lower than the threshold score, the validation module 140 instructs the training module 130 to re-train the DNN. In one embodiment, the training module 130 may iteratively re-train the DNN until the occurrence of a stopping condition, such as the accuracy measurement indication that the DNN may be sufficiently accurate, or a number of training rounds having taken place.

The inference module 150 applies the trained or validated DNN to perform tasks. The inference module 150 may run inference processes of a trained or validated DNN. In some examples, inference makes use of the forward pass to produce model-generated output for unlabeled real-world data. For instance, the inference module 150 may input real-world data into the DNN and receive an output of the DNN. The output of the DNN may provide a solution to the task for which the DNN is trained for.

The inference module 150 may aggregate the outputs of the DNN to generate a final result of the inference process. In some embodiments, the inference module 150 may distribute the DNN to other systems, e.g., computing devices in communication with the DNN system 100, for the other systems to apply the DNN to perform the tasks. The distribution of the DNN may be done through the interface module 110. In some embodiments, the DNN system 100 may be implemented in a server, such as a cloud server, an edge service, and so on. The computing devices may be connected to the DNN system 100 through a network. Examples of the computing devices include edge devices.

The datastore 160 stores data received, generated, used, or otherwise associated with the DNN system 100. For example, the datastore 160 stores video processed by the human activity analysis module 120 or used by the training module 130, validation module 140, and the inference module 150. The datastore 160 may also store other data generated by the training module 130 and validation module 140, such as the hyperparameters for training DNNs, internal parameters of trained DNNs (e.g., values of tunable parameters of activation functions, such as Fractional Adaptive Linear Units (FALUs)), etc. In the embodiment of FIG. 1, the datastore 160 is a component of the DNN system 100. In other embodiments, the datastore 160 may be external to the DNN system 100 and communicate with the DNN system 100 through a network.

### Example Human Activity Analysis System

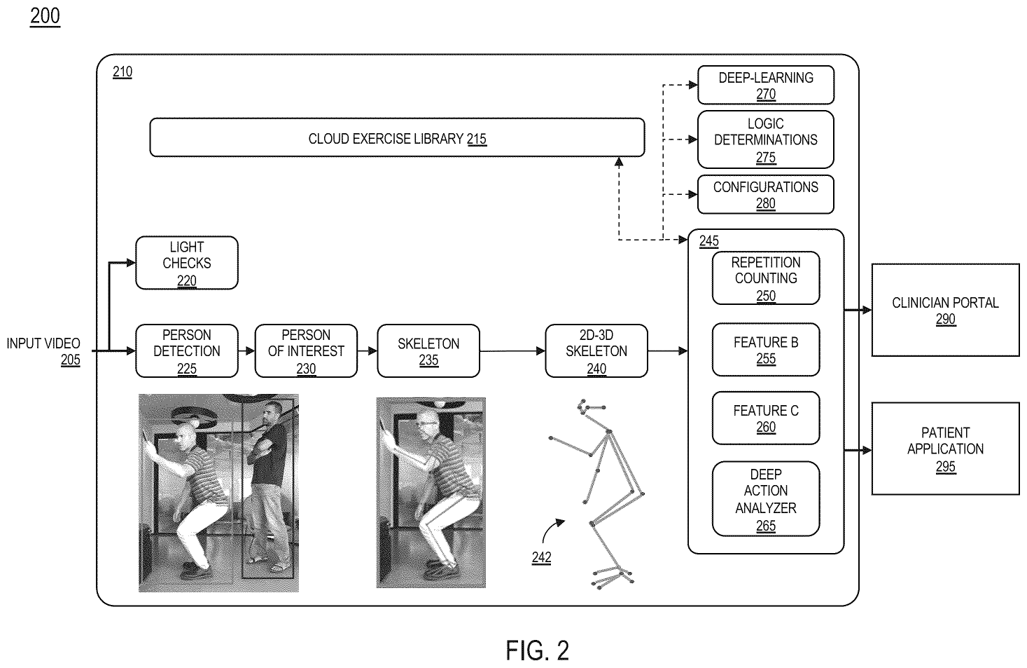

FIG. 2 illustrates an example 200 of a human activity analysis system, in accordance with various embodiments. In particular, as shown in FIG. 2, an input video 205 is received at a human activity analysis system 210. The human activity analysis system 210 includes an exercise library 215, a light check module 220, a person detection module 225, a person-of-interest identification module 230, a skeleton identification module 235, a 2D-3D skeleton generation module 240, an analysis module 245, a deep learning module 270, a logic determinations module 275, and a configurations module 280. The human activity analysis system 210 generates outputs to a clinician portal 290 and to a patient application 295.

In various examples, the exercise library 215 includes a set of exercises that a user may be performing. The set of exercises can include PT exercises. The human activity analysis system 210 receives an input video 205, and inputs the video to a light checks module 220. The light checks module 220 determines whether the lighting in the video is sufficient for detection (and analysis) of the person in the video. If the lighting is insufficient, the human activity analysis system 210 can output an alert to the patient application 295 to adjust lighting in the area in which the patient is performing (and recording) the exercises. The patient can then turn on lights, open curtains, or otherwise adjust the lighting until the light check alert from the light checks module 220 of the human activity analysis system 210 is no longer activated.

The human activity analysis system 210 receives the input video 205 at a person detection module 225, where any people present in the video are detected. At the person-of-interest module 230, the person performing the exercises is identified. Thus, if there are any bystanders or others in the room with the person performing the exercises, the system will remove the other people from its subsequent analysis. At the skeleton module 235, joints of the person performing the exercises are identified, and lines between the joints are generated to approximate a simplified skeleton. At the 2D-3D skeleton module 240, a simplified skeleton of the person performing the exercises is generated, as illustrated in the skeleton line-drawing 242 of FIG. 2. The 2D-3D skeleton module 240 saves the movement of the skeleton line-drawing 242 over time as skeleton sequences.

The skeleton sequences are output from the 2D-3D skeleton module 240 to an analysis module 245. The analysis module 245 counts the repetitions of the exercise at the repetition counting module 250. In some examples, when repetitions cannot be identified at the repetition counting module 250, the analysis is discontinued. When the repetitions of the exercise are identified by the repetition counting module 250, the analysis module 245 identifies various features of the exercise at the feature B module 255 and the feature C module 260. The analysis module also include a deep action analyzer 265 which analyzes the skeleton sequences and identifies any anomalies, as discussed in greater detail below. In various examples, the analysis module 245 can access the exercise library 215, a deep-learning system 270, logic determinations module 275, and configurations module 280. The analysis module 245 outputs its analysis to a clinician portal 290 and/or to a patient application 295.

In some examples, the analysis module 245 analyzes video clips that are around a few seconds long. For instance, the analysis module 245 may analyze video clips that are between about two seconds long and about four seconds long. In one example, the analysis module 245 analyzes video clips that are about three seconds long. The video clips can be overlapping, such that, in one example, a first video clip includes image frames from time zero seconds to time three seconds, a second video clip includes image frames from time one second to time four seconds, and a third video clip includes image frames from time two seconds to time five seconds.

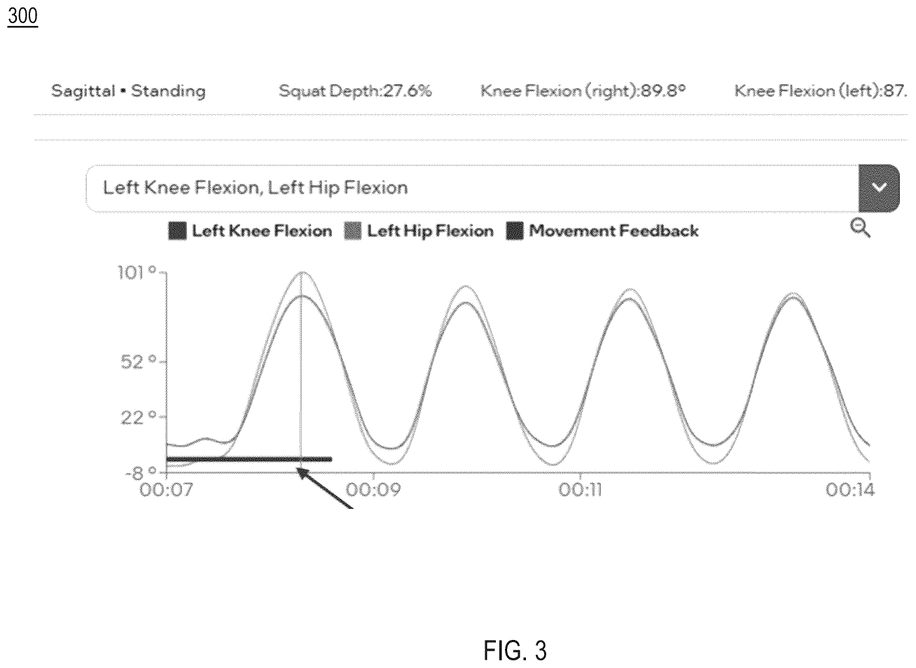

The clinician portal 290 can display a video of the patient performing the exercise and a graph illustrating movement over time. FIG. 3 illustrates an example of a graph that may be displayed to a clinician, in accordance with various embodiments. The graph 300 in FIG. 3 illustrates an angle of flexion of the knee over time and an angle of flexion of the hip over time when a patient is performing a one-legged squat. The corresponding video of the patient performing the squat can be displayed on the clinician portal 290 alongside the graph 300. In some examples, the graph 300 includes a vertical line that moves across the graph along the time dimension in synch with the patient movements being graphed. In some examples, a clinician can move to specific areas of the graph to see the corresponding video by clicking on the graph 300. In some examples, the graph 300 can highlight areas in which an anomaly is detected.

### Example Deep Action Analysis Pipeline

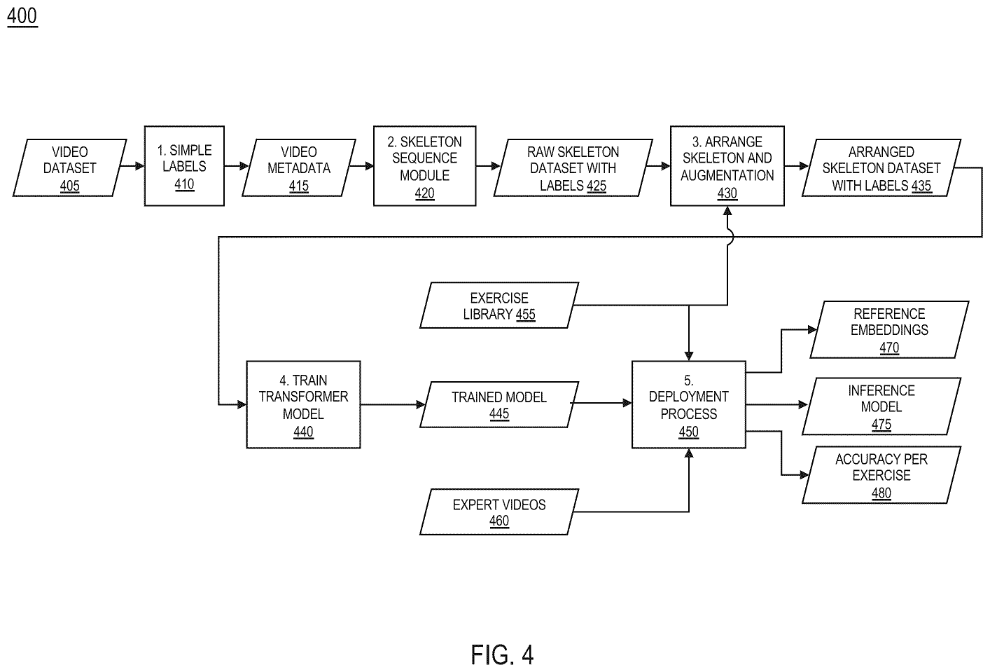

FIG. 4 illustrates an example overview of a deep action analysis development pipeline 400, in accordance with various embodiments. The deep action analysis development pipeline 400 includes multiple processes 410, 420, 430, 440, 450 as well as multiple files. The deep action analysis development pipeline 400 outputs an inference model 475 that can be used to perform deep action analysis on input videos in real time.

The deep action analysis development pipeline 400 receives a video dataset 405 as input. The video dataset 405 can include videos of many people performing specific exercises from an exercise list. In some examples, the exercise list can include the exercises in the exercise library 455. At the simple labels module 410, videos in the video dataset 405 are labeled. In some examples, each video in the video dataset 405 is labeled with one or more simple labels. The simple labels can include which exercise is performed in the video, which side of the body (right or left) is performing the exercise in the video (when applicable), and how many repetitions of the exercise are performed in the video. In some examples, simple labels can be added manually to each video. The simple labels module 410 outputs video metadata 415 including the labels for each video.

The video metadata 415 is input to a skeleton sequence module 420. The skeleton sequence module 420 receives each video from the video dataset 405 as well as the video metadata 415 including the simple labels for each video from the video dataset 405. The skeleton sequence module 420 extracts skeleton sequences from each video. In particular, as described in greater detail below, the skeleton sequence module 420 identifies joints of the exerciser in image frames of each video and generates a simple skeleton for the exerciser. For each video, using the simple skeleton in the image frames of the video, the skeleton sequence module 420 generates a labeled raw skeleton dataset. The labels on the raw skeleton dataset can include labels for each limb (e.g., left thigh, right calf). In some examples, the skeleton sequence module 420 also receives an auto-generated repetition count for each video based on the extracted skeleton sequences (e.g., from the repetition counting module 250 of FIG. 2). In some examples, the quality of the extracted skeleton sequences for each video can be evaluated based on the similarity between the auto-generated repetition count and the number of repetitions identified in the video metadata 415 generated by the simple labels module 410. In some examples, videos for which the auto-generated repetition count and the number of repetitions identified in the video metadata 415 are different are eliminated from the dataset at the skeleton sequence module 420.

The skeleton sequence module 420 outputs a raw skeleton dataset with labels 425. The labels may indicate the extracted skeleton sequences. The raw skeleton dataset with labels 425 in input into an arrange skeleton module 430. The arrange skeleton module 430 arranges the skeleton sequence in time as a three-dimensional (3D) array. In some examples, the dimensions of the 3D array include time, joints, and joint coordinates (e.g., [time, joints, joint coordinates]). The 3D array representing the skeleton sequence can be sectioned into segments (or slices), each represented a selected period of time. In one example, the 3D array representing the skeleton sequence is sectioned into segments that are about three seconds long. In other examples, the segments can be between about one second long and about five seconds long. In some examples, the segments for one video are the same length, and in some examples, the segments in a video are overlapping. According to some implementations, the length of time of each segment of the skeleton sequence is a balance between feedback latency and sequence length. For instance, the segment may be long enough to include a selected amount of exercise movement data for analysis while also being short enough to provide feedback to the exerciser in a timely manner. In one example, a video input includes thirty frames per second, and thus a three second segment of the video is ninety frames. In some implementations, the segments are input to a transformer that utilizes multiplications of 16, and a segment includes 96 frames. In various examples, a variable overlap time can be used between segments in order to provide augmentation to the skeleton sequence.

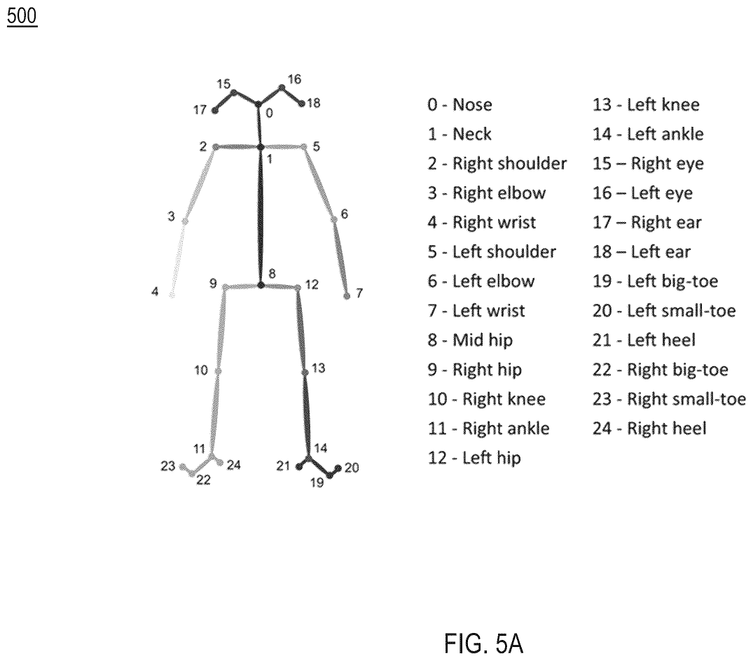

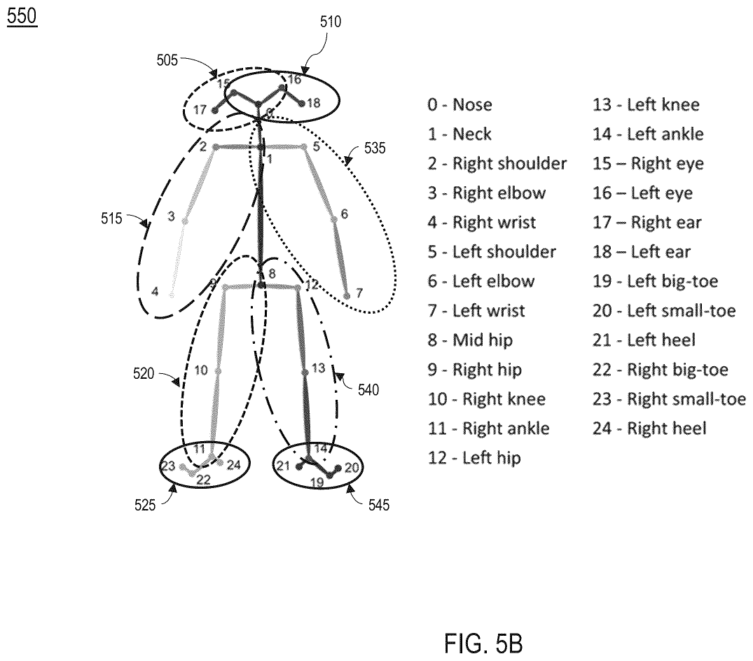

FIGS. 5A and 5B illustrate examples of a skeleton arrangement, in accordance with some embodiments. In particular, as shown in FIG. 5A, twenty-five joints are identified. As shown in FIG. 5B, the joints are grouped into eight groups, each group having four joints. Each group represents a human structure including body parts that generally move together when performing exercises. Note that there is overlap among the groups, such that some joints are included in multiple groups. As shown in FIG. 5A, selected skeleton joints and features are numbers using numbers zero through 24, where: joint 0 represents the nose, joint 1 represents the neck, joint 2 represents the right shoulder, joint 3 represents the right elbow, joint 4 represents the right wrist, joint 5 represents the left shoulder, joint 6 represents the left elbow, joint 7 represents the left wrist, joint 8 represents the mid hip, joint 9 represents the right hip, joint 10 represents the right knee, joint 11 represents the right ankle, joint 12 represents the left hip, joint 13 represents the left knee, joint 14 represents the left ankle, joint 15 represents the right eye, joint 16 represents the left eye, joint 17 represents the right ear, joint 18 represents the left ear, joint 19 represents the left big toe, joint 20 represents the left small toe, joint 21 represents the left heel, joint 22 represents right big toe, joint 23 represents the right small toe, and joint 24 represents the right heel.

As shown in FIG. 5B, joints 0-24 are grouped into eight groups. In particular, the right ear, right eye, nose, and left eye are grouped into a first group 505 (right head). The left ear, left eye, nose, and right eye are grouped into a second group 510 (left head). The neck, right shoulder, right elbow, and right wrist are grouped into a third group 515 (right arm). The mid hip, right hip, right knee, and right ankle are grouped into a fourth group 520 (right leg). The right ankle, right big toe, right small toe, and right heel are grouped into a fifth group 525 (right foot). The neck, left shoulder, left elbow, and left wrist are grouped into a sixth group 535 (left arm), the mid hip, left hip, left knee, and left ankle are grouped into a seventh group 540 (left leg), and the left ankle, left big toe, left small toe, and left heel are grouped into an eighth group 545 (left foot). In other examples, the eyes and ears are grouped together into one group, and the noise, neck, and mid-hip are grouped together into one group.

In various implementations, each skeleton group includes four joints. Each skeleton group of 4 joints can be duplicated 4 times to generate 16 sequential elements. Thus the dimension of the 3D array is expanded to 32*4=128 elements. The expansion operation can be completed to help utilize a Vision Transformer architecture for inference. In some examples, a vision Transformer architecture can receive as input a 16×16×3 array [time, joints, joint coordinates], with each 16×16×3 array considered a “patch” in which elements are processed together. In some examples, each 16×16×3 array represents 16 frames of human movement of a specific organ (e.g., one of groups 505, 510, 515, 520, 525, 530, 535, 540, 545). Sixteen frames in 30 frames per second represents 16/30 seconds (i.e., ˜½ second) which can be a sufficient time interval to analyze a partial movement of a human. When inferring using the 3D array and the systems and methods as described herein, the output includes an indication of which “patch” contributed to the inference results. That is, the output includes an indication of which body part or organ (i.e., which of the groups 505, 510, 515, 520, 525, 530, 535, 540, 545) contributed to the inference results.

Referring back to FIG. 4, the arrange skeleton module 430 arranges the skeleton sequence in time as the three-dimensional (3D) array and outputs the arranged skeleton dataset with labels 435. As noted above, in some examples, the dimensions of the 3D array include time, joints, and joint coordinates (e.g., [time, joints, joint coordinates]). The arrange skeleton module 430 also receives as input the exercise library 455, which includes the same joint information as the skeleton arrangements 500 and 550 shown in FIGS. 5A and 5B. In some examples, the exercise library information can be used to duplicate joint data for joints known to move in a selected exercise, thereby expanding the 3D array. In some examples, the 3D array is expanded up to 160 elements, and in some examples, the 3D array is expanded up to 224 elements. In some examples, the 3D array is expanded up to 160 elements and then padded with zeroes up to 224 elements. In some implementations, expanding the 3D array with the exercise library movements provides the model with additional “focus” on the expected movement joints. The model learns that the elements beyond the initial 128 elements best represent the ideal exercise movement. In some examples, the 3D array is padded with zeroes up to 224 elements in the time dimension. Thus, in some examples, the size of the 3D array can be [224 time elements, 224 joint elements, 3 joint coordinates].

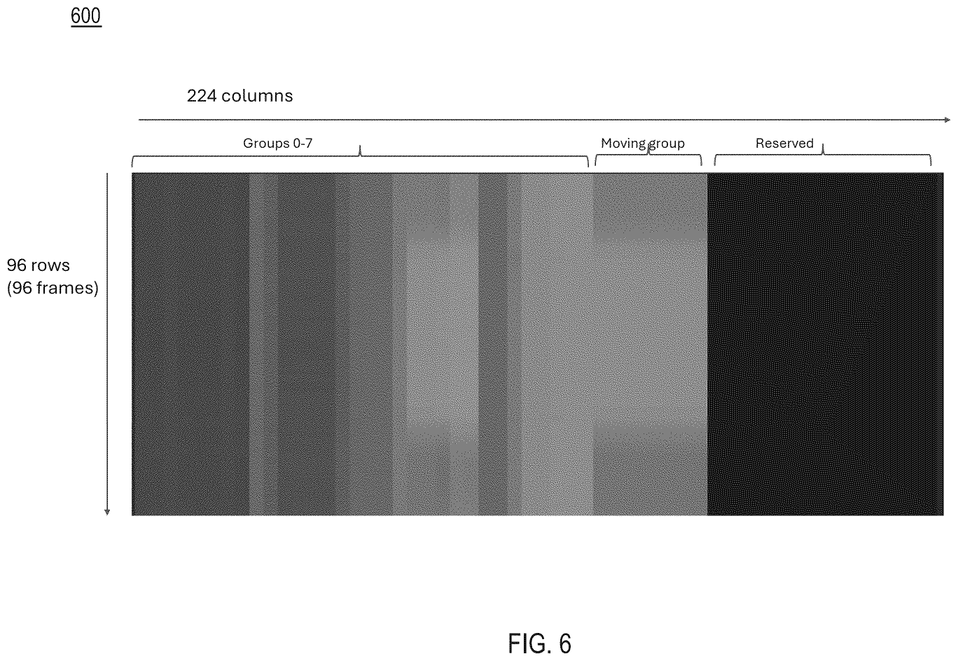

An example 600 of a 3D array output from the arrange skeleton module 430 is shown in FIG. 6, in accordance with various embodiments. In particular, FIG. 6 shows an array in which the first 128 columns are the arranged skeleton dataset based on the raw skeleton dataset with labels 425. The next 32 columns are the expanded array based on the exercise library 455. The remaining columns are simply padded with zeroes to expand the 3D array to a size expected by a corresponding transformer. In various examples, the 3D array can have other dimensions, and each the number of columns associated with the raw skeleton dataset with labels 425 can vary, the number of columns associated with the exercise library 455 can vary, and the number of columns that are padded can vary. In some examples, the 3D array includes no padded columns. IN some examples, the number of sequences added to the dataset per video depends on the video length.

The arranged skeleton dataset with labels 435 is input to the train transformer model module 440, which trains the inference model 475. The train transformer model module 440 performs a deep learning process for training the dataset. The training tasks for the train transformer model module 440 based on the simple labeling from simple labels module 410 include classifying the correct exercise and classifying whether the exercise is performed with the left or the right side (for one-sided exercises).

The trained model 445 is input to a deployment process module 450. The deployment process module 450 moves the transformer model to deployment using methods such as quantization, optimizations, compilation to target hardware, and so on. Part of the deployment that occurs at the deployment process module 450 can include integrating into the algorithm pipeline of FIG. 2. After deployment, the model can be used in real time. In some examples, the model can begin be used once 96 frames of video are accumulated. In some examples, every one second, three seconds of video (i.e., 96 frames of video) are processed by the model at a time.

The deployment process module 450 also receives expert videos 460 and prepares a database including embeddings of an expert performing the exercises in the exercise library 455.

The database including the embeddings of an expert performing the exercises can be the reference embeddings 470. In some examples, the reference embeddings are vector representations of the expert performing the exercises. The deployment process module 450 calculates embedding distances between multiple people doing the exercises and the expert embeddings, and also determines a distribution of distances from the expert. The embedding distances and the distribution of distances are also stored in a database, such as an accuracy per exercise database 480. The embedding distance can represent in a latent space the similarity between the expert and the person. If the distance is short, there is a similarity to the expert. If the distance is long, there is a greater difference from the expert. The patch that contributes the most to the embedding distance represents the body-part and time in which the biggest anomaly occurred. These two databases prepared by the deployment process module 450 are used to calculate how well the person performs the exercise relative to the normal population, and also used to determine which part of the exercise was not performed well. In some examples, the part of the exercise not performed well can be a portion of the exercise in time, a body part that moved differently than expected, or both. The output from the deployment process module 450 can include the reference embeddings 470, the accuracy per exercise database 480, and the inference model 475.

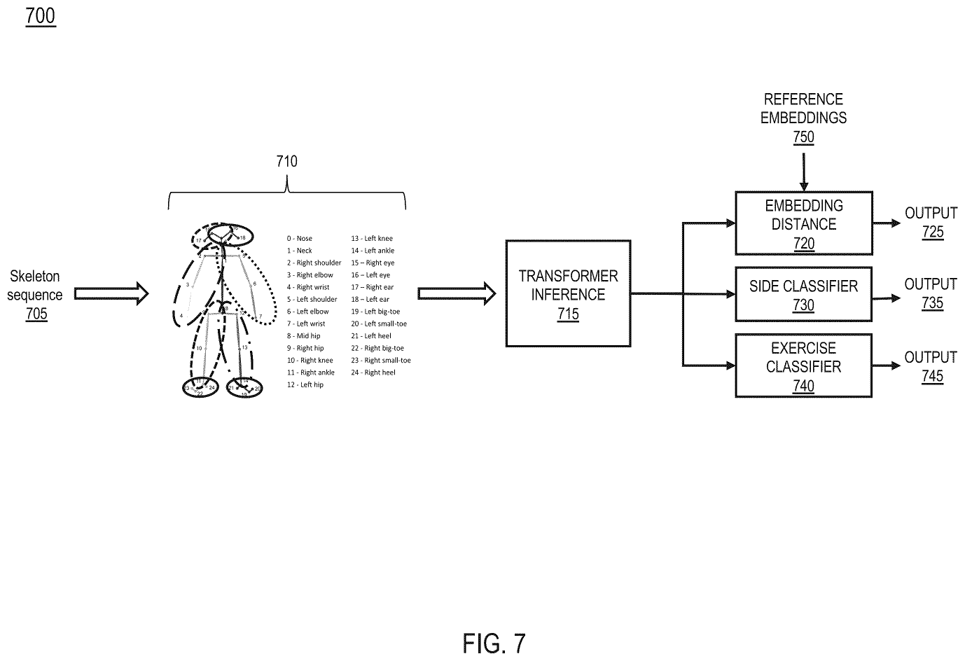

FIG. 7 illustrates an example deep action analysis pipeline 700, in accordance with various embodiments. In particular, the deep action analysis pipeline 700 illustrates a flow of deep action analysis inference. The deep action analysis pipeline 700 receives as input a skeleton sequence 705, such as the skeleton sequence discussed above. The skeleton sequence 705 can be an array having array elements representing time, joints, and joint coordinates. The skeleton sequence 705 is input to an arrange skeleton module 710. As described above with respect to FIGS. 5A and 5B, the arrange skeleton module 710 groups joints of the skeleton sequence 705 into multiple groups, each representing a human limb or organ. The output from the arrange skeleton module 710 is input to a transformer inference module 715.

The transformer inference module 715 determines embedding distances 720, and based on the embedding distances 720, the transformer inference module 715 outputs output 725 including embedding distances and embedding distance anomalies. When available, the transformer inference module 715 also identifies explanations for embedding distance anomalies, and the output 725 can include the explanation. The transformer inference module 715 also outputs the embeddings to a side classifier 730, which determines if an exercise is performed by one side of the body or is symmetrically performed. When an exercise is performed by one side of the body, the side classifier determines whether the left side of the body or the right side of the body is performing the exercise in the input, and outputs an output 735 identifying the side of the body performing the exercise. The transformer inference module 715 also outputs the embeddings to an exercise classifier 740, which identifies the exercise performed in the input and outputs an output 745 identifying the exercise. In some examples, the output 735 from the side classifier 730 and the output 745 from the exercise classifier are labels. In some examples, the outputs 725, 735, 745 are used by a patient application to inform an exerciser that they are performing the exercise incorrectly or to inform an exerciser that they are performing the exercise correctly. In some examples, the outputs 725, 735, 745 are used by clinician portal to inform an exerciser's physical therapist or other trainer that the exerciser is performing the exercise incorrectly or to inform an exerciser's physical therapist or other trainer that the exerciser is performing the exercise correctly.

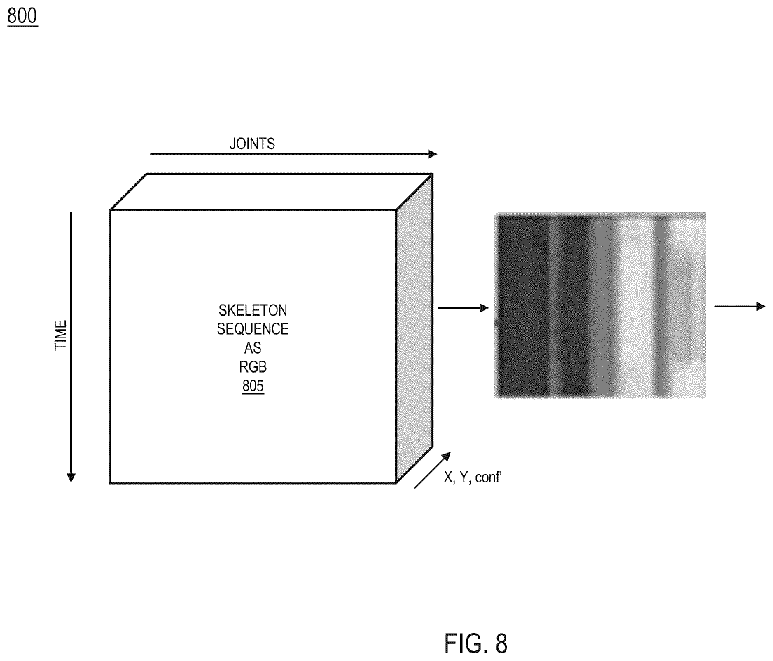

FIG. 8 illustrates a data preparation example 800, in accordance with various embodiments. In particular, in various examples, the output from an arrange skeleton module, such as the arrange skeleton module 710 of FIG. 7, can be transformed to a 3D array including time, joints, and joint coordinates and the skeleton sequence can be represented as a red-green-blue (RGB) array. In some examples, the 3D array including time, joints, and joint coordinates and the skeleton sequence can be represented as a green-blue array. In some examples, the skeleton sequence includes 25 joints tracked over three seconds.

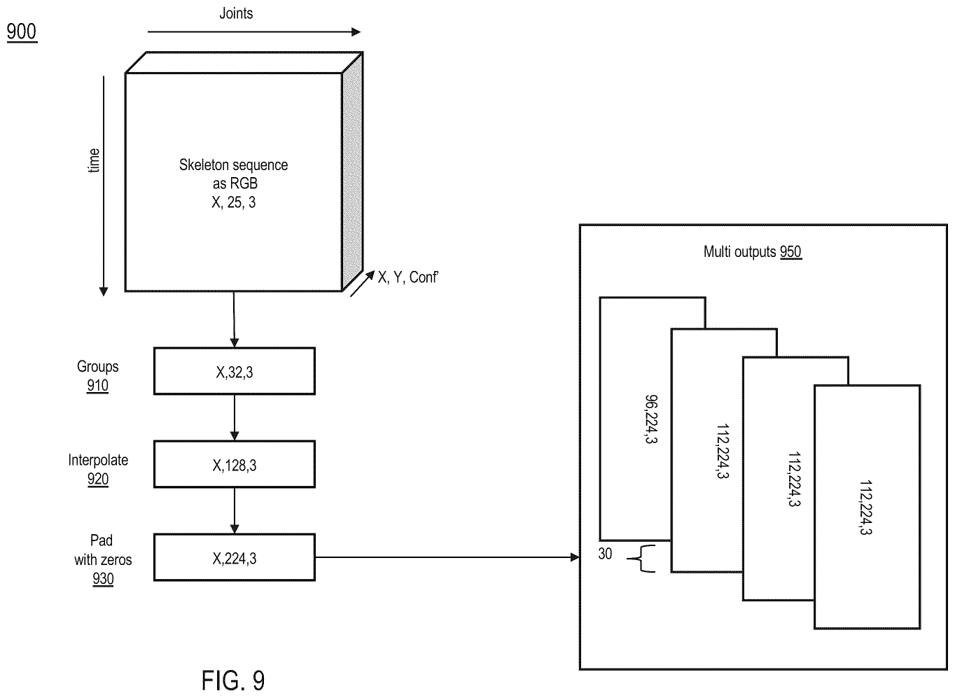

FIG. 9 illustrates an example generation of a 3D array, in accordance with various embodiments. In particular, the 25 joints can be grouped as discussed above with respect to FIG. 5B, and the groups can be represented as 32 array elements in three coordinates over three seconds. In some examples, at the interpolate stage, each skeleton group can be duplicated 4 times to generate 16 sequential elements. Thus the dimension of the 3D array is expanded to 32*4=128 elements. In some examples, the 3D array is expanded up to 224 elements. In some examples, the 3D array is expanded up to 160 elements and then padded with zeroes up to 224 elements. In some examples, the 3D array is padded with zeroes up to 224 elements in the time dimension. Thus, in some examples, the size of the 3D array can be [224 time elements, 224 joint elements, 3 joint coordinates]. In other examples, the time dimension can be variable. As shown in FIG. 9, the output can include 96 time elements, 112 time elements, or other selected numbers of time elements. The multi outputs 950 can be divided into multiple 16×16×3 arrays for input to a vision transformer. The expansion operation can be completed to help utilize a vision transformer architecture for inference. In some examples, a vision transformer architecture can receive as input a 16×16×3 array [time, joints, joint coordinates], with each 16×16×3 array considered a “patch” in which elements are processed together. In some examples, each 16×16×3 array represents 16 frames of human movement of a specific organ.

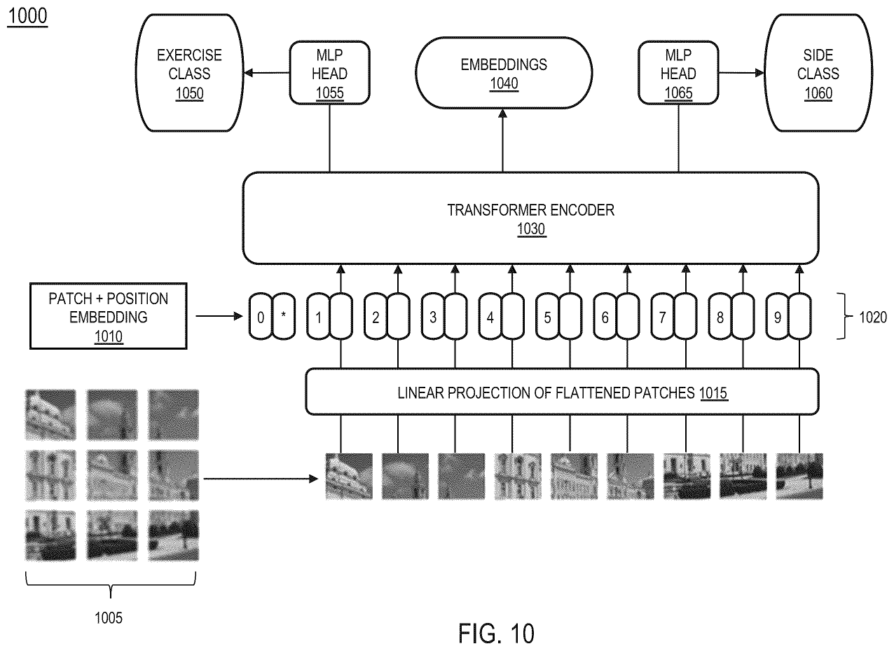

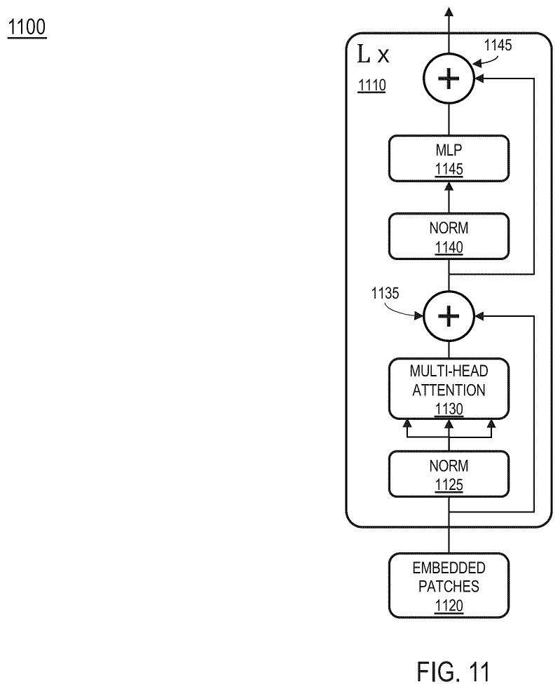

FIG. 10 illustrates an example of a vision transformer 1000, in accordance with various embodiments. The vision transformer receives the array generated by the skeleton sequence as RGB module, such as the multi outputs 950 of FIG. 9. As shown in FIG. 10, the input 1005 to the vision transformer is divided into multiple smaller arrays. In some examples, the smaller arrays 1005 are each 16×16×3 arrays, having 16 time elements, 16 joint group elements, and three x,y,z, coordinates. In other examples, the smaller arrays can have difference sizes. The patch plus position embedding module 1010 inputs the position of each of the smaller arrays (i.e., patches) in the larger input. Each of the smaller arrays are flattened, and a linear projection of each of the flattened smaller arrays is input to the transformer encoder 1030 along with the corresponding position of each smaller array 1020. The transformer encoder 1030 is discussed in greater detail with respect to FIG. 11.

The vision encoder 1030 outputs the exercise class 1050 (e.g., type of exercise identified by the transformer encoder 1030), the embeddings 1040, and the side class 1060 (e.g., the side of the exerciser's body on which the exercise is being performed, or whether it is a symmetrical exercise performed by both sides of the body simultaneously). In some examples, the vision encoder 1030 uses a multi-layer perceptron (MLP) head 1055 for classifying the exercise to generate the exercise class 1050. In some examples, the MLP head 1055 processes the output embeddings from the vision encoder 1030 to produce final predictions. Similarly, in some examples, the vision encoder 1030 uses a multi-layer perceptron (MLP) head 1065 for classifying the side the exercise is performed on to generate the side class 1060. In some examples, the MLP head 1065 processes the output embeddings from the vision encoder 1030 to produce final predictions.

FIG. 11 illustrates an example 1100 of a transformer encoder 1110, in accordance with various embodiments. The transformer encoder 1110 receives the embedded patches 1120 as input. The embedded patches 1120 can be small arrays that make up the input array representing the video segment of the exercise. In some examples, the embedded patches are the smaller arrays 1020 described with respect to FIG. 10. In some examples, the embedded patches 1120 are 16×16×3 element arrays, with 16 elements representing time, 16 elements representing a joint group, and 3 elements representing xyz coordinates of the joint group.

The embedded patches 1120 are processed at a norm module 1125 and the normed output is received at a multi-head attention module 1130. The norm module 1125 normalizes values of the embedded patches 1120 to generate the normed output. In some examples, the norm module 1125 normalizes the values to (−1, 1). In some examples, the normed output can include Q (Query), K (Key), and V (Value) outputs, which are input to the multi-head attention module 1130. In some examples, the multi-head attention module 1130 includes multiple self-attention heads running in parallel, with each head focusing on different parts of the input. In some examples, the multi-head attention module 1130 processes the input to capture complex patterns in the input. The output from the multi-head attention module 1130 is added to the embedded patches 1120 at a first adder 1135, and the output from the adder 1135 is input to a second norm module 1140. The norm module 1140 normalizes values of the input values to generate a normed output. In some examples, the normed output can include Q (Query), K (Key), and V (Value) outputs. The output from the norm module 1140 is input to a multi-layer perceptron 1145, which classifies the encoded embeddings to identify the exercise and the side of the body (right, left, both) performing the exercise. The outputs from the multi-layer perceptron 1145 are input to a second adder 1150 where the outputs from the multi-layer perceptron 1145 are added to the outputs from the first adder 1135. The second adder 1150 output is the output from the transformer encoder 1110.

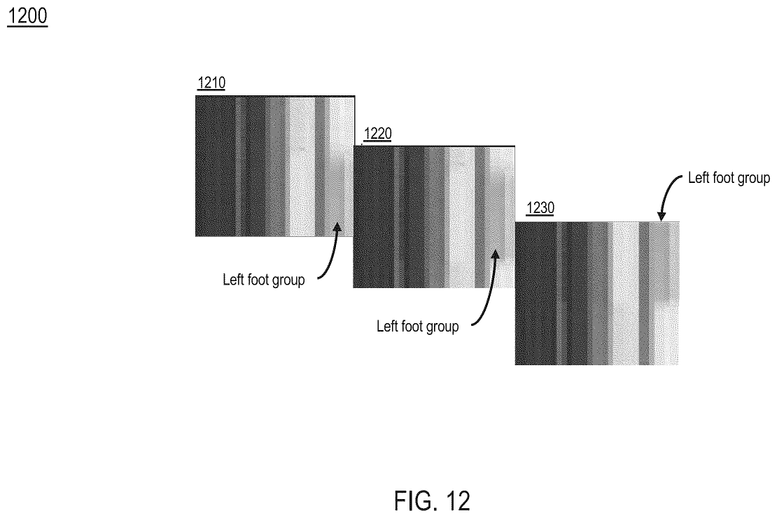

FIG. 12 illustrates an example 1200 of three arrays 1210, 1220, 1230 that may be analyzed by a vision transformer, such as the vision transformer 1000, in accordance with various embodiments. In particular, each of the arrays 1210, 1220, 1230 encodes joint groups and joint coordinate movements over time. The first array 1210 represents movement in a first video segment. The second array 1220 represents movement in a second video segment, subsequent to the first video segment. The third array 1230 represents movement in a third video segment, subsequent to the second video segment. In the first array 1210, the left foot group is represented on the right hand side of the array and is positioned at the bottom of the array. In the second array 1220, the left foot group is represented on the right hand side of the array and is positioned vertically in the middle of the array. In the third array 1230, the left foot group is represented on the right hand side of the array and is positioned at the top of the array. In this manner, the succession of arrays 1210, 1220, 1230 encode movement of the left foot group. Note that other elements of the arrays 1210, 1220, 1230 represent other joint groups, which in the exercise being performed are stationary and thus remain the same across the arrays 1210, 1220, 1230.

### Example Method of Human Activity Analysis

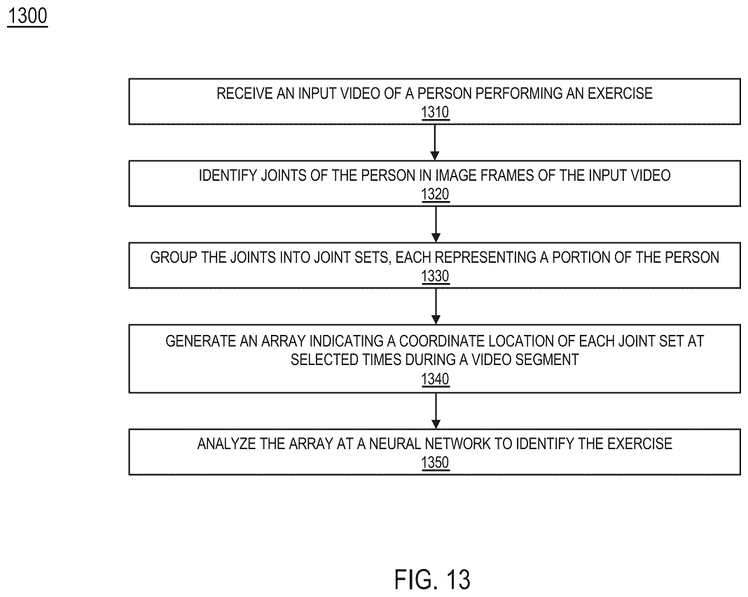

FIG. 13 is a flowchart showing a method 1300 of human activity analysis, in accordance with various embodiments. The method 1300 may be performed by the deep learning system 100 in FIG. 1. Although the method 1300 is described with reference to the flowchart illustrated in FIG. 13, many other methods for human activity analysis may alternatively be used. For example, the order of execution of the elements of FIG. 13 may be changed. As another example, some of the elements may be changed, eliminated, or combined.

At 1310, an input video of a person performing an exercise is received. The input video includes multiple image frames. At 1320, the person's joints are identified in the image frames. In particular, selected joints of the person are identified, such as the wrist, the elbow, the shoulder, the neck, the hip, the knee, the ankle, etc. The joints are identified on both sides of the patient (e.g., right wrist, left wrist, right elbow, left elbow, right shoulder, left shoulder, etc.). An example list of joints is described above with respect to FIGS. 5A and 5B.

At 1330, the identified joints are grouped into joint sets, with each joint set representing a portion of the person. In particular, each joint set represents a limb, a body organ, or other connected body part, as described above with respect to FIG. 5B. At 1340, an array is generated to represent each joint set and its movement over time. In particular, the array indicates a coordinate location of each joint set at each image frame (and/or at selected time points) of a video segment. The video segment can be a short clip of the input video, such as a 2 second portion of the input video, a three second portion of the input video, or a four second portion of the input video. In some examples, the video segment can be from 1.5 seconds to about 5 seconds long.

At 1350, the array is analyzed at a neural network to identify the exercise. The neural network is a deep learning system, and the neural network can be a transformer as described herein. The neural network can also identify the side of the body performing the exercise in the video segment (e.g., right side, left side, or, for symmetrical exercises, both sides). In some examples, the neural network can compare the exercise performed in the video segment to an expert version of the exercise and identify anomalies in the exercise as performed in the video segment. Anomalies can indicate incorrect performance of the exercise. In some examples, the anomalies identified by the neural network can be output to a user interface to inform the exerciser of the incorrect movement and/or inform a physical therapist or trainer working with the exerciser.

### Example Computing Device

FIG. 14 is a block diagram of an example computing device 1400, in accordance with various embodiments. In some embodiments, the computing device 1400 may be used for at least part of the deep learning system 100 in FIG. 1. A number of components are illustrated in FIG. 14 as included in the computing device 1400, but any one or more of these components may be omitted or duplicated, as suitable for the application. In some embodiments, some or all of the components included in the computing device 1400 may be attached to one or more motherboards. In some embodiments, some or all of these components are fabricated onto a single system on a chip (SoC) die. Additionally, in various embodiments, the computing device 1400 may not include one or more of the components illustrated in FIG. 14, but the computing device 1400 may include interface circuitry for coupling to the one or more components. For example, the computing device 1400 may not include a display device 1406, but may include display device interface circuitry (e.g., a connector and driver circuitry) to which a display device 1406 may be coupled. In another set of examples, the computing device 1400 may not include a video input device 1418 or a video output device 1408, but may include video input or output device interface circuitry (e.g., connectors and supporting circuitry) to which a video input device 1418 or video output device 1408 may be coupled.

The computing device 1400 may include a processing device 1402 (e.g., one or more processing devices). The processing device 1402 processes electronic data from registers and/or memory to transform that electronic data into other electronic data that may be stored in registers and/or memory. The computing device 1400 may include a memory 1404, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1404 may include memory that shares a die with the processing device 1402. In some embodiments, the memory 1404 includes one or more non-transitory computer-readable media storing instructions executable for occupancy mapping or collision detection, e.g., the method 1300 described above in conjunction with FIG. 13, and/or some operations performed by the DNN system 100 in FIG. 1, and/or any of the systems and/or pipelines of FIGS. 2, 4, 7, 10, and/or 11. The instructions stored in the one or more non-transitory computer-readable media may be executed by the processing device 1402.

In some embodiments, the computing device 1400 may include a communication chip 1412 (e.g., one or more communication chips). For example, the communication chip 1412 may be configured for managing wireless communications for the transfer of data to and from the computing device 1400. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 1412 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1412 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1412 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1412 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1412 may operate in accordance with other wireless protocols in other embodiments. The computing device 1400 may include an antenna 1422 to facilitate wireless communications and/or to receive other wireless communications (such as AM or FM radio transmissions).

In some embodiments, the communication chip 1412 may manage wired communications, such as electrical, optical, or any other suitable communication protocols (e.g., the Ethernet). As noted above, the communication chip 1412 may include multiple communication chips. For instance, a first communication chip 1412 may be dedicated to shorter-range wireless communications such as Wi-Fi or Bluetooth, and a second communication chip 1412 may be dedicated to longer-range wireless communications such as global positioning system (GPS), EDGE, GPRS, CDMA, WiMAX, LTE, EV-DO, or others. In some embodiments, a first communication chip 1412 may be dedicated to wireless communications, and a second communication chip 1412 may be dedicated to wired communications.

The computing device 1400 may include battery/power circuitry 1414. The battery/power circuitry 1414 may include one or more energy storage devices (e.g., batteries or capacitors) and/or circuitry for coupling components of the computing device 1400 to an energy source separate from the computing device 1400 (e.g., AC line power).

The computing device 1400 may include a display device 1406 (or corresponding interface circuitry, as discussed above). The display device 1406 may include any visual indicators, such as a heads-up display, a computer monitor, a projector, a touchscreen display, a liquid crystal display (LCD), a light-emitting diode display, or a flat panel display, for example.

The computing device 1400 may include a video output device 1408 (or corresponding interface circuitry, as discussed above). The video output device 1408 may include any device that generates an audible indicator, such as speakers, headsets, or earbuds, for example.

The computing device 1400 may include a video input device 1418 (or corresponding interface circuitry, as discussed above). The video input device 1418 may include any device that generates a signal representative of a sound, such as microphones, microphone arrays, or digital instruments (e.g., instruments having a musical instrument digital interface (MIDI) output).

The computing device 1400 may include a GPS device 1416 (or corresponding interface circuitry, as discussed above). The GPS device 1416 may be in communication with a satellite-based system and may receive a location of the computing device 1400, as known in the art.

The computing device 1400 may include another output device 1410 (or corresponding interface circuitry, as discussed above). Examples of the other output device 1410 may include a video codec, a video codec, a printer, a wired or wireless transmitter for providing information to other devices, or an additional storage device.

The computing device 1400 may include another input device 1420 (or corresponding interface circuitry, as discussed above). Examples of the other input device 1420 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1400 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1400 may be any other electronic device that processes data.

### SELECTED EXAMPLES

The following paragraphs provide various examples of the embodiments disclosed herein.

Example 1 provides a computer-implemented method, including receiving an input video of a person performing an exercise, the input video including a plurality of image frames; identifying a plurality of joints of the person in each of the plurality of image frames; grouping the plurality of joints into a plurality of joint sets, each joint set representing a portion of the person; generating an array indicating a coordinate location of each joint set at selected times during a first video segment; and analyzing the array at a neural network to identify the exercise.

Example 2 provides the computer-implemented method of example 1, where the neural network is a transformer.

Example 3 provides the computer-implemented method according to any of examples 1-2, where the neural network identifies a side of the person performing the exercise, where the side is one of a right side, a left side, and both sides.

Example 4 provides the computer-implemented method according to any of examples 1-3, where the neural network receives reference embeddings representing expert exercises and identifies anomalies in the exercise performed by the person based on a corresponding expert exercise.

Example 5 provides the computer-implemented method according to any of examples 1-4, where the array is a first array, and further including dividing the first array into a plurality of smaller second arrays, and where analyzing the first array includes analyzing the plurality of smaller second arrays.

Example 6 provides the computer-implemented method of example 5, where each of the plurality of second arrays are a same size, and further including inputting the plurality of second arrays and corresponding positions of each of the plurality of second arrays to the deep learning system.

Example 7 provides the computer-implemented method according to any of examples 1-6, further including determining a number of repetitions of the exercise performed in the input video.

Example 8 provides the computer-implemented method according to any of examples 1-7, where the first video segment is between about two seconds long and about five seconds long.

Example 9 provides the computer-implemented method according to any of examples 1-8, where the plurality of joint sets include a first joint set representing a right arm portion of the person, a second joint set representing a right leg portion of the person, and a third joint set representing a right foot portion of the person.

Example 10 provides the computer-implemented method according to any of examples 1-9, where the plurality of joint sets include a first joint set representing a left arm portion of the person, a second joint set representing a left leg portion of the person, and a third joint set representing a left foot portion of the person.

Example 11 provides one or more non-transitory computer-readable media storing instructions executable to perform operations, the operations including receiving an input video of a person performing an exercise, the input video including a plurality of image frames; identifying a plurality of joints of the person in each of the plurality of image frames; grouping the plurality of joints into a plurality of joint sets, each joint set representing a portion of the person; generating an array indicating a coordinate location of each joint set at selected times during a first video segment; analyzing the array at a deep learning system to identify the exercise,

Example 12 provides the one or more non-transitory computer-readable media of example 10, where the deep learning system is a transformer.

Example 13 provides the one or more non-transitory computer-readable media of example 10, where the deep learning system identifies a side of the person performing the exercise, where the side is one of a right side, a left side, and both sides.

Example 14 provides the one or more non-transitory computer-readable media of example 10, where the deep learning system receives reference embeddings representing expert exercises and identifies anomalies in the exercise performed by the person based on a corresponding expert exercise.

Example 15 provides the one or more non-transitory computer-readable media of example 10, where the array is a first array, and further including dividing the first array into a plurality of smaller second arrays, and where analyzing the first array includes analyzing the plurality of smaller second arrays.

Example 16 provides the one or more non-transitory computer-readable media of example 14, where each of the plurality of second arrays are a same size, and further including inputting the plurality of second arrays and corresponding positions of each of the plurality of second arrays to the deep learning system.

Example 17 provides an apparatus, including a computer processor for executing computer program instructions; and a non-transitory computer-readable memory storing computer program instructions executable by the computer processor to perform operations including receiving an input video of a person performing an exercise, the input video including a plurality of image frames; identifying a plurality of joints of the person in each of the plurality of image frames; grouping the plurality of joints into a plurality of joint sets, each joint set representing a portion of the person; generating an array indicating a coordinate location of each joint set at selected times during a first video segment; analyzing the array at a deep learning system to identify the exercise,

Example 18 provides the apparatus of example 17, where the deep learning system is a transformer.

Example 19 provides the apparatus according to any of examples 17-18, where the deep learning system identifies a side of the person performing the exercise, where the side is one of a right side, a left side, and both sides.

Example 20 provides the apparatus according to any of examples 17-19, where the deep learning system receives reference embeddings representing expert exercises and identifies anomalies in the exercise performed by the person based on a corresponding expert exercise.

Example 21 provides the apparatus according to any of examples 17-20, where the array is a first array, and further including dividing the first array into a plurality of smaller second arrays, and where analyzing the first array includes analyzing the plurality of smaller second arrays.

Example 22 provides the computer-implemented method, non-transitory computer medium, and/or apparatus of any of the above or below examples, wherein the first joint set represents a right arm portion of the person and includes a neck joint, a right should joint, a right elbow joint, and a right wrist joint.

Example 23 provides the computer-implemented method, non-transitory computer medium, and/or apparatus of any of the above or below examples further comprising identifying the side of the body performing the exercise in the video segment (e.g., right side, left side, or, for symmetrical exercises, both sides).

Example 24 provides the computer-implemented method, non-transitory computer medium, and/or apparatus of any of the above or below examples further comprising comparing, by the neural network, the exercise performed in the video segment to an expert version of the exercise and identifying anomalies in the exercise as performed in the video segment.

Example 25 provides the computer-implemented method, non-transitory computer medium, and/or apparatus of any of the above or below examples, further comprising outputting an indication of the detected anomalies to a user interface.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A computer-implemented method, comprising:
receiving an input video of a person performing an exercise, the input video including a plurality of image frames;
identifying a plurality of joints of the person in each of the plurality of image frames;
grouping the plurality of joints into a plurality of joint sets, each joint set representing a portion of the person;
generating an array indicating a coordinate location of each joint set at selected times during a first video segment; and
analyzing the array at a neural network to identify the exercise.

2. The computer-implemented method according to claim 1, wherein the neural network is a transformer.

3. The computer-implemented method according to claim 1, wherein the neural network identifies a side of the person performing the exercise, wherein the side is one of a right side, a left side, and both sides.

4. The computer-implemented method according to claim 1, wherein the neural network receives reference embeddings representing expert exercises and identifies anomalies in the exercise performed by the person based on a corresponding expert exercise.

5. The computer-implemented method according to claim 1, wherein the array is a first array, and further comprising dividing the first array into a plurality of second arrays, each of the plurality of second arrays smaller than the first array, and wherein analyzing the first array includes analyzing the plurality of second arrays.

6. The computer-implemented method according to claim 5, wherein each of the plurality of second arrays are a same size, and further comprising inputting the plurality of second arrays and corresponding positions of each of the plurality of second arrays to the neural network.

7. The computer-implemented method according to claim 1, further comprising determining a number of repetitions of the exercise performed in the input video.

8. The computer-implemented method according to claim 1, wherein the first video segment is between about two seconds long and about five seconds long.

9. The computer-implemented method according to claim 1, wherein the plurality of joint sets include a first joint set representing a right arm portion of the person, a second joint set representing a right leg portion of the person, and a third joint set representing a right foot portion of the person.

10. The computer-implemented method according to claim 1, wherein the plurality of joint sets include a first joint set representing a left arm portion of the person, a second joint set representing a left leg portion of the person, and a third joint set representing a left foot portion of the person.

11. One or more non-transitory computer-readable media storing instructions executable to perform operations, the operations comprising:
receiving an input video of a person performing an exercise, the input video including a plurality of image frames;
identifying a plurality of joints of the person in each of the plurality of image frames;
grouping the plurality of joints into a plurality of joint sets, each joint set representing a portion of the person;
generating an array indicating a coordinate location of each joint set at selected times during a first video segment; and
analyzing the array at a deep learning system to identify the exercise.

12. The one or more non-transitory computer-readable media according to claim 11, wherein the deep learning system is a transformer.

13. The one or more non-transitory computer-readable media according to claim 11, wherein the deep learning system identifies a side of the person performing the exercise, wherein the side is one of a right side, a left side, and both sides.

14. The one or more non-transitory computer-readable media according to claim 11, wherein the deep learning system receives reference embeddings representing expert exercises and identifies anomalies in the exercise performed by the person based on a corresponding expert exercise.

15. The one or more non-transitory computer-readable media according to claim 11, wherein the array is a first array, and further comprising dividing the first array into a plurality of second arrays, each of the plurality of second arrays smaller than the first array, and wherein analyzing the first array includes analyzing the plurality of second arrays.

16. The one or more non-transitory computer-readable media according to claim 15, wherein each of the plurality of second arrays are a same size, and further comprising inputting the plurality of second arrays and corresponding positions of each of the plurality of second arrays to the deep learning system.

17. An apparatus, comprising:
a computer processor for executing computer program instructions; and
a non-transitory computer-readable memory storing computer program instructions executable by the computer processor to perform operations comprising:
receiving an input video of a person performing an exercise, the input video including a plurality of image frames;
identifying a plurality of joints of the person in each of the plurality of image frames;
grouping the plurality of joints into a plurality of joint sets, each joint set representing a portion of the person;
generating an array indicating a coordinate location of each joint set at selected times during a first video segment; and
analyzing the array at a deep learning system to identify the exercise.

18. The apparatus according to claim 17, wherein the deep learning system is a transformer.

19. The apparatus according to claim 17, wherein the deep learning system identifies a side of the person performing the exercise, wherein the side is one of a right side, a left side, and both sides.

20. The apparatus according to claim 17, wherein the deep learning system receives reference embeddings representing expert exercises and identifies anomalies in the exercise performed by the person based on a corresponding expert exercise.
